(19) United States
(12) Patent Application Publication
(10) Pub. No.: US 2016/0154163 A1
(43) Pub. Date: Jun. 2, 2016

(54) BACKLIGHT ASSEMBLY AND DISPLAY DEVICE HAVING THE SAME

(71) Applicant: Samsung Display Co., Ltd., Yongin-si (KR)

(72) Inventors: Hyeonggyu JANG, Asan-si (KR); Jaeho YOU, Gwangmyeong-si (KR); Moongyu LEE, Suwon-si (KR); Byoungho CHEONG, Yongin-si (KR)

(21) Appl. No.: 14/951,137

(22) Filed: Nov. 24, 2015

(30) Foreign Application Priority Data
Nov. 28, 2014 (KR) 10-2014-0168491

(51) Int. Cl. F21V 8/00; G02B 5/30

(52) U.S. Cl. CPC G02B 6/005; G02B 6/0053; G02B 5/3066; G02B 5/3083; G02B 6/0073; G02B 6/0068

(57) ABSTRACT

A display device includes a backlight assembly generating a light and a display panel receiving the light to display an image. The backlight assembly includes a light emitting unit, a light guide plate, a prism plate, and a reflective polarizing plate. The light guide plate guides the light emitted from the light emitting unit to the display panel. The prism plate is disposed between the light guide plate and the display panel and includes reverse prisms to refract the light. The reflective polarizing plate is disposed between the prism plate and the display panel.

### CLAIM OF PRIORITY

This U.S. non-provisional patent application claims the priority of and all the benefits accruing under 35 U.S.C. §119 of Korean Patent Application No. 10-2014-0168491, filed on Nov. 28, 2014 in the Korean Intellectual Property Office (KIPO), the contents of which are hereby incorporated by reference in its entirety.

### BACKGROUND OF THE INVENTION

1. Field of disclosure

The present disclosure relates to a backlight assembly and a display device displaying an image using a light provided from the backlight assembly.

2. Description of the Related Art

A display device, such as a liquid crystal display device, includes a backlight assembly generating a light and a display panel displaying an image using the light generated by the backlight assembly. The backlight assembly includes a light emitting unit emitting the light, a light guide plate guiding the light emitted from the light emitting unit to the display panel, and an optical member controlling a path of the light exiting from the light guide plate.

As the optical member, a diffusion plate and a prism sheet are widely used. The diffusion plate diffuses the light exiting from the light guide plate. In addition, the prism sheet refracts the light inclinedly incident thereto to allow the light to travel along a direction substantially vertical to the prism sheet, and thus a front brightness of the display device is improved by the prism sheet.

### SUMMARY OF THE INVENTION

The present disclosure provides a backlight assembly having improved brightness in a side direction.

The present disclosure provides a display device having improved display quality.

Embodiments of the inventive concept provide a display device including a backlight assembly generating a light and a display panel receiving the light to display an image.

The backlight assembly includes a light emitting unit, a light guide plate, a prism plate, and a reflective polarizing plate. The light guide plate guides the light emitted from the light emitting unit to the display panel. The prism plate is disposed between the light guide plate and the display panel and includes reverse prisms to refract the light. The reflective polarizing plate is disposed between the prism plate and the display panel.

Embodiments of the inventive concept provide a backlight assembly including a light emitting unit, a light guide plate, a prism plate, and a reflective polarizing plate. The light emitting unit emits a light and the light guide plate receives the light emitted from the light emitting unit. The prism plate is disposed on the light guide plate and includes reverse prisms (i.e. a base of each prism faces the display panel and a tip of each prism faces a direction opposite to the display panel) to refract the light. The reflective polarizing plate faces the light guide plate to allow the prism plate to be disposed between the reflective polarizing plate and the light guide plate.

According to the above, the backlight assembly includes a light guide plate having a wedge shape, a prism plate including the reverse prisms and the ¼ wavelength retardation plate, and the reflective polarizing plate, and the light reproduced by the reflective polarizing plate and the ¼ wavelength retardation plate is refracted by the reverse prisms. Therefore, the side brightness of the display panel is improved, and the visibility of the image displayed on the display panel may be prevented from being deteriorated even though a user's viewing direction is inclined to an upper or lower side of the display panel.

### BRIEF DESCRIPTION OF THE DRAWINGS

The above and other advantages of the present disclosure will become readily apparent by reference to the following detailed description when considered in conjunction with the accompanying drawings wherein:

FIG. 1A is an exploded perspective view showing a display device according to an exemplary embodiment of the present disclosure, FIG. 1B is an exploded perspective view showing a display device according to a comparison example;

FIG. 2 is a cross-sectional view taken along a line I-I′ shown in FIG. 1A;

FIG. 3 is a partially enlarged view showing a first area shown in FIG. 2;

FIG. 4 is a cross-sectional view showing a reflective polarizing plate, a prism plate, and a light guide plate;

FIG. 5 is a graph showing a brightness as a function of an emission angle of an exemplary embodiment and a comparison example; and

FIG. 6 is a cross-sectional view showing a display device according to another exemplary embodiment of the present disclosure.

### DETAILED DESCRIPTION OF THE INVENTION

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

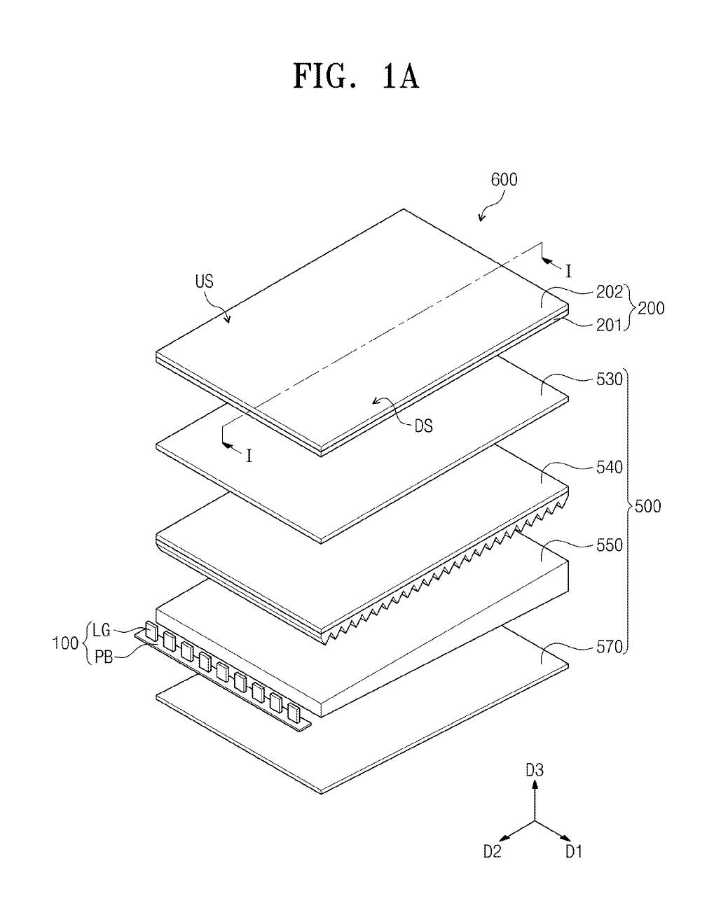

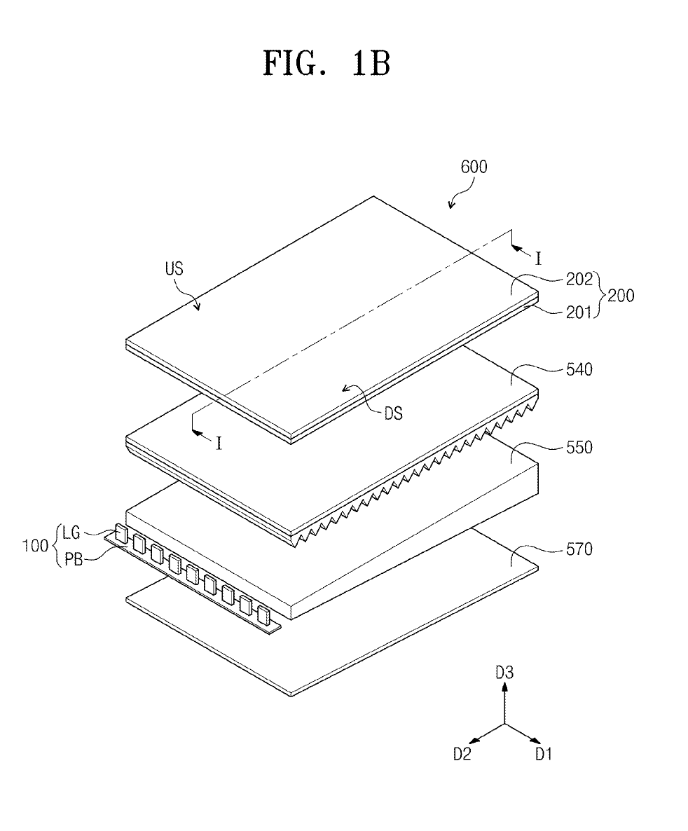

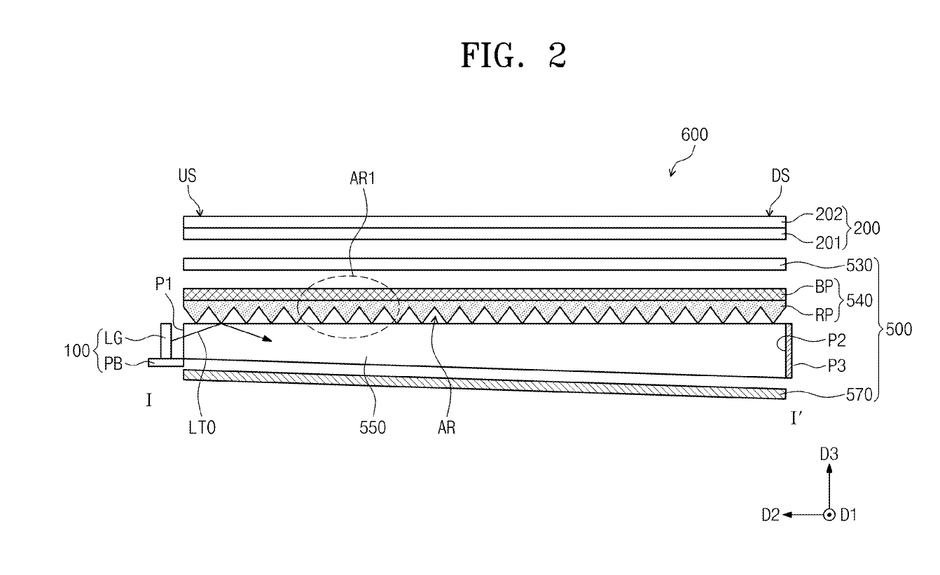

FIG. 1A is an exploded perspective view showing a display device 600 according to an exemplary embodiment of the present disclosure, FIG. 1B is an exploded perspective view showing a display device according to a comparison example, FIG. 2 is a cross-sectional view taken along a line I-I′ shown in FIG. 1A, and FIG. 3 is a partially enlarged view showing a first area AR1 shown in FIG. 2.

Referring to FIGS. 1A, 1B, 2, and 3, the display device 600 includes a display panel 200 and a backlight assembly 500. The display device 600 may be applied to a notebook computer to display information.

The display panel 200 displays an image using a light provided from the backlight assembly 500. The display panel 200 includes a display substrate 201, an opposite substrate 202, and a liquid crystal layer (not shown) interposed between the display substrate 201 and the opposite substrate 202.

The display substrate 201 includes a plurality of pixel electrodes (not shown) arranged in a plurality of pixel areas, respectively, and the opposite substrate 202 includes a common electrode (not shown) facing the pixel electrodes. However, the structure of the display panel 200 should not be limited thereto or thereby. For instance, according to embodiment, the common electrode may be disposed on the display substrate 201 rather than the opposite substrate 202.

The backlight assembly 500 includes a light emitting unit 100, a reflective member 570, a light guide plate 550, a prism plate 540, and a reflective polarizing plate 530.

The light emitting unit 100 is disposed adjacent to one side portion of the light guide plate 550 to emit a light LT0, and the light LT0 is incident to the light guide plate 550. The light emitting unit 100 includes a printed circuit board PCB and a plurality of light emitting diode packages LG. The light emitting diode packages LG are mounted on the printed circuit board PCB and emit the light LT0.

In the present exemplary embodiment, the light emitting diode packages LG are arranged along the side portion of the light guide plate 550, but the position and the number of the light emitting diode packages LG should not be limited to any specific position and number. According to an embodiment, another light emitting unit may be disposed adjacent to another side portion of the light guide plate 550.

The reflective member 570 has a light reflective characteristic and is disposed adjacent to a bottom surface of the light guide plate 550. The reflective member 570 reflects the light exiting through the bottom surface of the light guide plate 550 and the light reflected by the reflective member 570 is incident to the light guide plate 550 again.

In the present exemplary embodiment, the reflective member 570 has a form of a sheet with a thickness in a range from a few micrometer (×1 μm) to hundreds of micrometers (×10² μm). According to another embodiment, the reflective member 570 may be coated on the bottom surface of the light guide plate 550.

The light guide plate 550 is disposed on the reflective member 570. The light guide plate 550 includes a light incident portion P1 to which the light emitted from the light emitting unit 100 is incident, an opposite portion P2 facing the light incident portion P1, and a light reflective portion P3 disposed on the opposite portion P2.

The light LT0 emitted from the light emitting unit 100 is incident to the light guide plate 550 through the light incident portion P1 and the incident light LT0 travels to the opposite portion P2 and is reflected by the light reflective portion P3.

In the present exemplary embodiment, the light guide plate 550 has a wedge shape such that a thickness of the light guide plate 550 decreases as a distance from the light incident portion P1 decreases, and the thickness of the light guide plate 550 increases as a distance from the opposite portion P2 decreases.

Meanwhile, an angle at which the light LT0 is reflected in the light guide plate 550 is varied while the light LT0 travels to the light incident portion P1 after being reflected by the light reflective portion P3 in the light guide plate 550 since the thickness of the light guide plate 550 is not constant. In this case, when an angle with respect to a line perpendicular to the surface at which the light LT0 is reflected in the light guide plate 550 is greater than a critical angle of the light guide plate 550, a total internal reflection of the light LT0 within the light guide plate 550 occurs; when the angle is less than the critical angle, the light LT0 exits from the light guide plate 550 and passes to the prism plate 540.

The prism plate 540 is disposed between the light guide plate 550 and the reflective polarizing plate 530. The prism plate 540 includes reverse prisms RP to refract the light traveling between the light guide plate 550 and the reflective polarizing plate 540.

The reverse prisms RP extend in a first direction D1 and are arranged in a second direction D2 substantially vertical to the first direction D1. In addition, the reverse prisms RP include a plurality of prism mountains PT1 and a plurality of prism valleys PT2, and the prism mountains PT1 are disposed more adjacent to the light guide plate 550 than the prism valleys PT2. Therefore, an air layer AR may be defined between the prism plate 540 and the light guide plate 550 and the prism mountains PT1 make contact with the light guide plate 550.

In the present exemplary embodiment, the prism plate 540 may further include a base portion BP and the reverse prisms RP are disposed on the base portion BP. In addition, the base portion BP includes a base film FL1 (which can be a ¼ wavelength retardation plate) and a ¼ wavelength retardation plate FL2 coupled to the base film FL1. Therefore, the prism plate 540 refracts the light passing through the light guide plate 550 and the reflective polarizing plate 530 and retards a phase of the light.

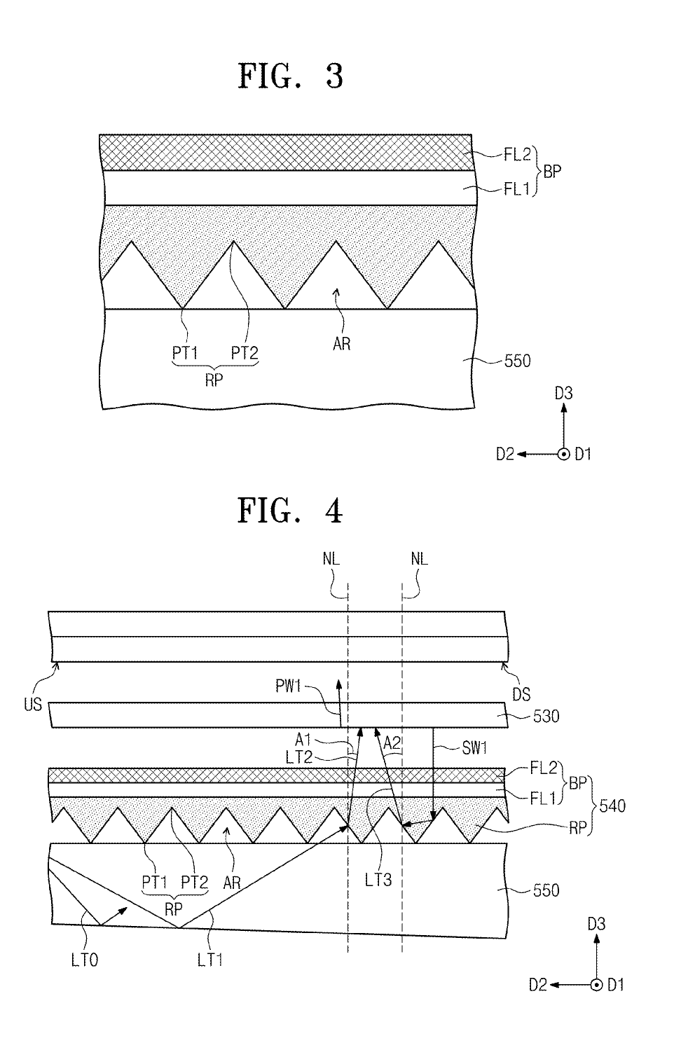

The reflective polarizing plate 530 is disposed between the prism plate 540 and the display panel 200 and transmits or reflects the light according to a direction in which the polarization of the light vibrates. In the present exemplary embodiment, the reflective polarizing plate 530 transmits a P wave of the light and reflects an S wave of the light. The reflective polarizing plate 530 will be described in detail with reference to FIG. 4.

FIG. 4 is a cross-sectional view showing the reflective polarizing plate 530, the prism plate 540, and the light guide plate 550.

Referring to FIG. 4, the light emitted from the light emitting unit 100 (FIG. 1A) is reproduced by the reflective polarizing plate 530 and a path of the reproduced light is controlled by the prism plate 540.

The light LT0 emitted from the light emitting unit is incident to the light guide plate 550. When the light LT0 incident to the light guide plate 550 is reflected in the light guide plate 550, the light LT0 may exit from the light guide plate 550 in the case that the reflected angle is smaller than the critical angle.

A light exited from the light guide plate 550, i.e. “first light LT1”, is refracted by the reverse prisms RP. The light refracted by the reverse prisms RP is referred to as a second light LT2, and a direction in which the second light LT2 travels is closer to a normal line NL of the display panel 200 than a direction in which the first light LT1 travels. Thus, the front brightness of the display panel 200 is improved by the reverse prisms RP.

The reflective polarizing plate 530 transmits a first P wave PW1 of the second light LT2 and reflects a first S wave SW1 of the second light LT2. The first P wave PW1 transmits through the reflective polarizing plate 530 and is used to display the image on the display panel 200 and the first S wave SW1 travels to the prism plate 540.

Then, the first S wave SW1 is refracted by the reverse prisms RP and travels to the display panel 200. When the light refracted by the reverse prisms RP is referred to as a third light LT3, a second emission angle A2 of the third light LT3 is greater than a first emission angle A1 of the second light LT2. For example, in the present exemplary embodiment, the first emission angle A1 is about ±9 degrees as viewed relative to the normal line direction NL and the second emission angle A2 is about ±20 degrees as viewed relative to the normal line direction NL.

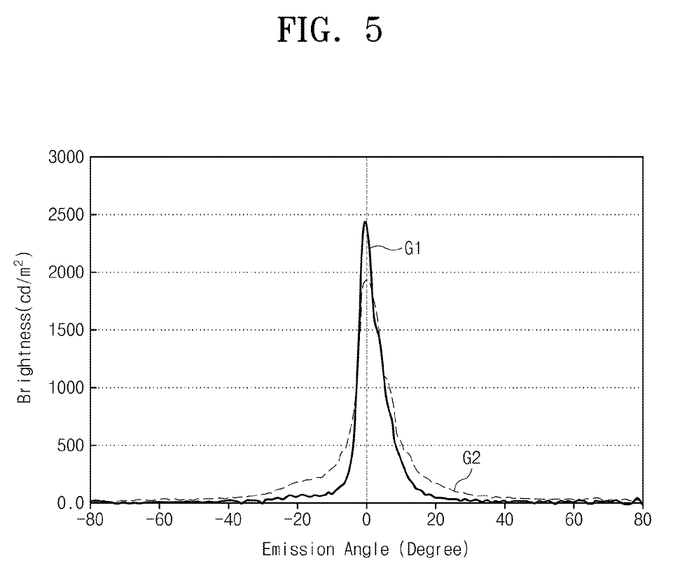

While a brightness of the display panel 200, which is perceived by a user when the user's viewing direction is substantially parallel to the normal line direction NL, corresponds to the “front brightness” of the display panel 200; a brightness of the display panel 200, which is perceived by the user when the user's viewing direction is inclined to an upper side US or a lower side DS of the display panel 200, corresponds to the “side brightness” of the display panel 200. Different from the present exemplary embodiment, in the comparison example, the reflective polarizing plate 530 is omitted from the backlight assembly 500 (refer to FIG. 1B), the second light LT1 traveling along the first emission angle Al is provided to the display panel 200 and the front brightness of the display panel 200 is improved, but the side brightness of the display panel 200 is lowered (see graph G1 in FIG. 5).

However, according to the present exemplary embodiment, since the second light LT2 and the third light LT3 traveling along the second emission angle A2 are provided to the display panel 200 by the prism plate 540, the side brightness may be improved. Accordingly, although the user views the display panel 200 at the upper side US or the lower side DS, the brightness of the display panel 200 is sufficiently high, thereby improving visibility of the image displayed through the display panel 200.

In addition, the first S wave SW1 passes two times through the 1/4 wavelength retardation plate FL2 while the first S wave SW1 transmits through the prism plate 540 and is refracted by the reverse prisms RP. When the first S wave SW1 passes one time through the ¼ wavelength retardation plate FL2, the wavelength of the first S wave SW1 is retarded by a quarter wavelength. Accordingly, the wavelength of the first S wave SW1 is retarded by a half wavelength while the first S wave SW1 passes two times through the ¼ wavelength retardation plate FL2, and as a result, the third light LT3, in which the first S wave SW1 is refracted, is converted to the P wave.

Consequently, the first S wave SW1 reflected by the reflective polarizing plate 530 is converted to the P wave transmitting through the display panel 200, and the P wave is used to display the image on the display panel 200 after transmitting through the reflective polarizing plate 530.

FIG. 5 is a graph showing the brightness of the display panel 200 as a function of the emission angle.

Referring to FIGS. 4 and 5, a first graph G1 represents the brightness of a comparison example. In the comparison example, the reflective polarizing plate 530 and the ¼ wavelength retardation plate FL2 are omitted from the backlight assembly 500 (refer to FIG. 2). A second graph G2 represents the brightness of the embodiment example of the present disclosure. In the embodiment example, the backlight assembly 500 includes the reflective polarizing plate 530 and the ¼ wavelength retardation plate FL2.

Referring to the first graph G1, when the emission angle of the light emitted toward the display panel 200 is in a range from about +8 degrees to about −8 degrees, the display panel 200 has the brightness of about 200 cd/m². However, referring to the second graph G2, when the emission angle of the light emitted toward the display panel 200 is in a range from about +20 degrees to about −20 degrees, the display panel 200 has the brightness of about 200 cd/m².

That is, according to the present exemplary embodiment, although the emission angle is in a range from about ±9 degrees to about ±20 degrees, the brightness equal to or greater than about 200 cd/m² may be easily obtained. Therefore, the side brightness of the display panel 200 is improved. As a result, even though the user's view direction is inclined to the upper side US or the lower side DS of the display panel 200 from the normal line direction NL, the visibility of the image displayed on the display panel 200 may be prevented from being deteriorated due to the deterioration of the brightness.

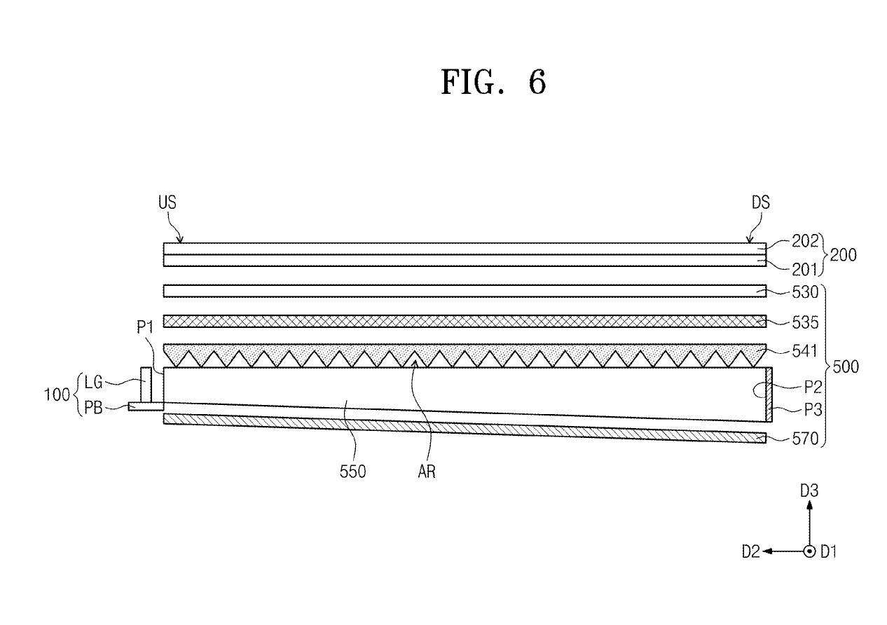

FIG. 6 is a cross-sectional view showing a display device according to another exemplary embodiment of the present disclosure. In FIG. 6, the same reference numerals denote the same elements in FIG. 2, and thus detailed descriptions of the same elements will be omitted.

Referring to FIG. 6, a backlight assembly 501 includes a light emitting unit 100, a reflective member 570, a light guide plate 550, a prism plate 541, and a reflective polarizing plate 530, and a ¼ wavelength retardation plate 535.

When comparing the prism plate 541 to the prism plate 540 (refer to FIG. 2), the prism plate 541 includes reverse prisms, but does not convert the phase of the light. Alternatively, the ¼ wavelength retardation plate 535 is disposed between the prism plate 541 and the reflective polarizing plate 530 and has a sheet shape. The ¼ wavelength retardation plate 535 has the same optical function as that of the ¼ wavelength retardation plate FL2 (refer to FIG. 2).

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A display device comprising:
a backlight assembly generating a light; and
a display panel receiving the light to display an image, the backlight assembly comprising:
a light emitting unit emitting the light;
a light guide plate guiding the light emitted from the light emitting unit to the display panel;
a prism plate disposed between the light guide plate and the display panel and comprising reverse prisms to refract the light; and
a reflective polarizing plate disposed between the prism plate and the display panel.

2. The display device of claim 1, wherein the prism plate comprises a base portion and a prism pattern disposed on the base portion, and the prism pattern is disposed between the base portion and the light guide plate.

3. The display device of claim 2, wherein the base portion comprises a ¼ wavelength retardation plate.

4. The display device of claim 2, wherein the backlight assembly further comprises a ¼ wavelength retardation plate disposed between the prism plate and the reflective polarizing plate.

5. The display device of claim 1, wherein the light guide plate comprises:
a light incident portion to which the light emitted from the light emitting unit is incident;
an opposite portion facing the light incident portion; and
a light reflective portion disposed on the opposite portion.

6. The display device of claim 5, wherein the light guide plate has a thickness decreasing as a distance from the light incident portion decreases and increasing as a distance from the opposite portion decreases.

7. The display device of claim 1, wherein the reverse prisms comprise a plurality of prism mountains and a plurality of prism valleys, and the prism mountains are disposed more adjacent to the light guide plate than the prism valleys.

8. The display device of claim 7, wherein the light emitting unit comprises a plurality of light emitting diode packages arranged in a first direction along one side portion of the light guide plate, and the reverse prisms extend in the first direction.

9. A backlight assembly comprising:
a light emitting unit emitting a light;
a light guide plate receiving the light emitted from the light emitting unit;
a prism plate disposed on the light guide plate and comprising reverse prisms to refract the light; and
a reflective polarizing plate facing the light guide plate to allow the prism plate to be disposed between the reflective polarizing plate and the light guide plate.

10. The backlight assembly of claim 9, wherein the prism plate comprises a base portion and a prism pattern disposed on the base portion, and the prism pattern is disposed between the base portion and the light guide plate.

11. The backlight assembly of claim 10, wherein the base portion comprises a ¼ wavelength retardation plate.

12. The backlight assembly of claim 10, further comprising a ¼ wavelength retardation plate disposed between the prism plate and the reflective polarizing plate.

13. The backlight assembly of claim 9, wherein the light guide plate comprises:
a light incident portion to which the light emitted from the light emitting unit is incident;
an opposite portion facing the light incident portion; and
a light reflective portion disposed on the opposite portion.

14. The backlight assembly of claim 13, wherein the light guide plate has a thickness decreasing as a distance from the light incident portion decreases and increasing as a distance from the opposite portion decreases.

15. The backlight assembly of claim 9, wherein the reverse prisms comprise a plurality of prism mountains and a plurality of prism valleys, and the prism mountains are disposed more adjacent to the light guide plate than the prism valleys.

16. The backlight assembly of claim 15, wherein the light emitting unit comprises a plurality of light emitting diode packages arranged in a first direction along one side portion of the light guide plate, and the reverse prisms extend in the first direction.
